(19) United States
(12) Patent Application Publication
(10) Pub. No.: US 2025/0016821 A1
(43) Pub. Date: Jan. 9, 2025

(54) MANAGING PREEMPTION IN MULTI-LINK OPERATIONS

(71) Applicant: Cisco Technology, Inc., San Jose, CA (US)

(72) Inventors: Domenico FICARA, Essertines-Sur-Yverdon (CH); Pascal THUBERT, Roquefort Les Pins (FR); Amine CHOUKIR, Ecublens (CH)

(21) Appl. No.: 18/477,233

(22) Filed: Sep. 28, 2023

Related U.S. Application Data
(60) Provisional application No. 63/512,558, filed on Jul. 7, 2023.

(51) Int. Cl. H04W 72/566; H04W 28/06

(52) U.S. Cl. CPC H04W 72/569; H04W 28/06; H04W 88/10

(57) ABSTRACT

Techniques for coordinating traffic and performing preemption in multi-link operations are provided. At least a first portion of a first element of data is transmitted by the first network device via a first link. A second element of data is identified by the first network device. The transmission of the first element of data is interrupted by the first network device to transmit the second element of data via the first link. A remaining portion of the first element of data is transmitted by the first network device via a second link.

### CROSS-REFERENCE TO RELATED APPLICATIONS

This application claims benefit of co-pending U.S. provisional patent application Ser. No. 63/512,558 filed Jul. 7, 2023. The aforementioned related patent application is herein incorporated by reference in its entirety.

### TECHNICAL FIELD

Embodiments presented in this disclosure generally relate to wireless communication. More specifically, embodiments disclosed herein relate to improved preemption in multi-link operations (MLO).

### BACKGROUND

Preemption for deterministic services, a feature commonly associated with Time-Sensitive Networking (TSN), represents a significant advancement in network traffic management. This technique ensures that deterministic traffic (e.g., time-sensitive traffic) is prioritized and transmitted on time. This key functionality reduces latency for high-priority tasks and ensures reliable data transmission, thereby enhancing the performance and efficiency of time-sensitive applications. Preemption generally involves allowing data from specific services to interrupt other (non-deterministic or non-priority) data when being transmitted via a network, ensuring that the deterministic data is delivered in a timely fashion.

The WiFi 802.11 standard has evolved significantly, transitioning from single-radio to multi-radio technology and introducing the concept of Multi-Link Operation (MLO) to enhance the overall network's performance and reliability. MLO functions by allowing a client device to connect to multiple other devices (e.g., access points) and transmit or receive data across multiple links simultaneously. Through the MLO, the client device may maintain several connections concurrently, thereby increasing its total throughput and improving the reliability of the network.

The present disclosure provides a mechanism for the integration of preemption techniques within the MLO, ensuring the timely transmission of high-priority traffic (e.g., time-sensitive traffic) and lower-priority traffic, even in complicated MLO environments.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example environment that supports preemption for a multi-link device (MLD), according to some embodiments of the present disclosure.

FIG. 2 depicts an example environment for multi-link operation (MLO), according to some embodiments of the present disclosure.

FIG. 3 depicts a time diagram for handling preemptions between different links, according to some embodiments of the present disclosure.

FIG. 4 depicts an example method for coordinating uplink data transmissions across multiple links by a station multi-link device (STA MLD), according to some embodiments of the present disclosure.

FIG. 5 depicts an example method for coordinating downlink data transmissions across multiple links, according to some embodiments of the present disclosure.

FIG. 6 depicts an example method for receiving data transmissions across multiple links, according to some embodiments of the present disclosure.

FIG. 7 is a flow diagram depicting an example method for traffic coordination and preemption in MLO, according to some embodiments of the present disclosure.

FIG. 8 depicts an example computing device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including transmitting, by a first network device, at least a first portion of a first element of data via a first link, identifying, by the first network device, a second element of data, interrupting, by the first network device, the transmission of the first element of data to transmit the second element of data via the first link, and transmitting, by the first network device, a remaining portion of the first element of data via a second link.

Other embodiments in this disclosure provide non-transitory computer-readable mediums containing computer program code that, when executed by operation of one or more computer processors, performs operations in accordance with one or more of the above methods, as well as systems comprising one or more computer processors and one or more memories containing one or more programs which, when executed by the one or more computer processors, performs an operation in accordance with one or more of the above methods.

### EXAMPLE EMBODIMENTS

The present disclosure provides techniques for integrating preemption for deterministic services into MLO systems. The integration would ensure that high-priority traffic (e.g., time-sensitive traffic) is transmitted without delay, even in complicated MLO environments, while also improving throughput for non-priority (or lower-priority) traffic. In this way, embodiments of the present disclosure can substantially improve the overall performance and efficiency of applications that use or rely on data transmissions. In some embodiments, when non-deterministic traffic is preempted by higher-priority data, the non-deterministic traffic can be moved to another link, thereby prioritizing the deterministic traffic. For example, in one aspect, a client device that is capable of multi-link operation (MLO) may establish communication with one or more access points (APs) through multiple links, and transmit and/or receive frames via one (or more) of these links. When deterministic traffic (e.g., time-sensitive traffic that requires immediate attention and rapid transmission) arrives or is ready for transmission, the transmitting device (e.g., the client device or the AP) may interrupt the ongoing transmission of non-deterministic frames, moving these non-deterministic frames to another link. In some embodiments, upon the preemption of the non-deterministic transmission, the client device or the AP may initiate the immediate transmission of the deterministic traffic via the link that was previously carrying the non-deterministic transmission (referred to in some aspects as the primary or initial link).

In the configuration described above, preemption occurs between links within the same client device and AP, ensuring the timely transmission of deterministic traffic. In another embodiment, the preemption operations may be performed between different APs. For example, a local wireless network may include multiple APs, each acting as a multi-link device and serving as a hub for the transmission and receipt of data. A client device supporting multi-AP MLO may connect to the first AP via a dedicated communication link (e.g., link 1), and establish a concurrent connection to the second AP via a different communication link (e.g., link 2). When non-deterministic traffic is being transmitted to (or received from) the first AP via link 1, and deterministic traffic arrives, the preemption operations may be triggered, where the client device or the first AP preempts the ongoing transmission of the non-deterministic frames, moving this traffic from link 1 to link 2, and immediately initiates the transmission of the deterministic frames via link 1. The non-deterministic traffic, now shifted to link 2, continues its transmission to (or reception from) the second AP without significantly affecting the overall network performance. The preemption may ensure the immediate and prioritized transmission of deterministic data without compromising the transmission of standard, non-deterministic data.

By extending preemption techniques into MLO environments, the advantages of high network reliability and throughput offered by the MLO can be effectively combined with the assurance of timely transmission for high-priority data provided by preemption, leading to highly efficient, robust, and timely communication across the network.

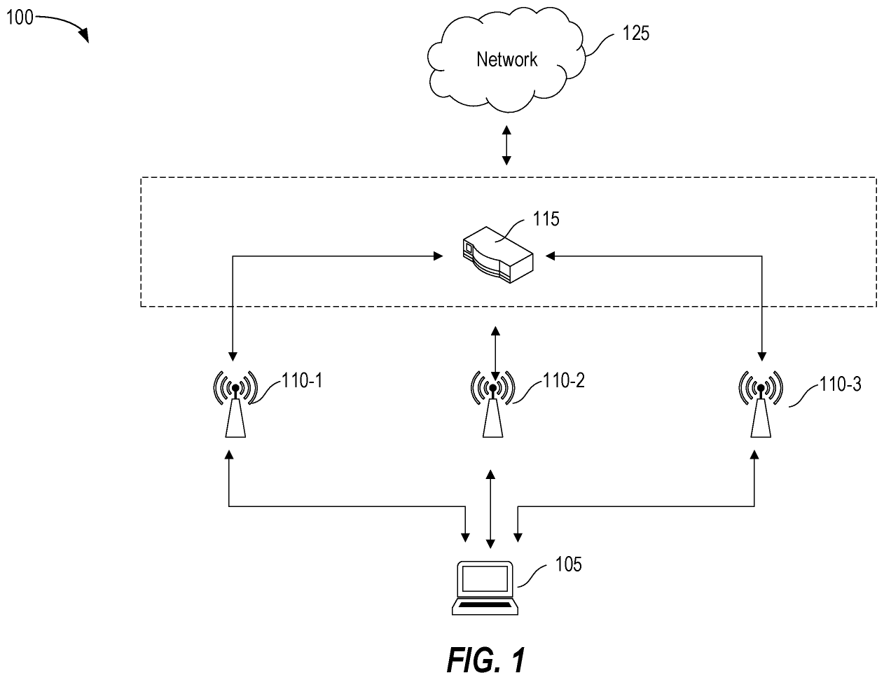

FIG. 1 depicts an example environment 100 that supports preemption for a multi-link device (MLD), according to some embodiments of the present disclosure. The illustrated environment 100 comprises a STA MLD 105 (e.g., a station or client device that acts as a multi-link device), three AP MLDs 110-1, 110-2, and 110-3 (e.g., access points that act as multi-link devices), and a wireless LAN controller (WLC) 115.

In the illustrated environment 100, the STA MLD 105 has the capability to establish connections with all three AP MLDs 110-1, 110-2, and 110-3, setting up one or more communication links between the station and each of the access points. Though three APs are depicted for conceptual clarity, there may be any number of APs in the environment and/or involved in the MLO system. Through the different communication links, the STA MLD 105 may receive or transmit data with one or multiple AP MLDs. For example, the STA MLD 105 may receive downlink data from the AP MLD 110-1 via one link, and simultaneously (or non-simultaneously) upload uplink data to the AP MLD 110-1 via a different link. In some embodiments, when the STA MLD 105 connects to both the AP MLDs 110-1 and 110-2, the STA MLD 105 may transmit one type of data (e.g., non-deterministic data) to AP MLD 110-1 via the first link, and simultaneously transmit another type of data (e.g., deterministic or time-sensitive data) to AP MLD 110-2 via the second link. In some embodiments, when the STA MLD 105 connects to both the AP MLDs 110-1 and 110-2, the STA MLD 105 may continuously or periodically monitor and evaluate the link quality of its connections with both AP MLD 1 and AP MLD 2. In some embodiments, the link quality may be evaluated by considering metrics like throughput, latency, and/or stability. Based on the evaluation, the STA MLD 105 and/or AP MLD(s) may choose the best link (e.g., highest throughput and stability) for data transmission, ensuring optimal performance for all types of data. When there is a need to accommodate deterministic data (e.g., which is time sensitive and requires low-latency communications), the STA MLD 105 may move its regular traffic from the primary (best) link to the secondary one, leaving the primary (best) link free for the deterministic data demands.

These individual links may operate on different frequency bands (e.g., 2.4 GHz, 5 GHz, or 6 GHZ) and/or use separate communication channels. As used herein, “non-deterministic” or “preempted” data may refer to the type of data that is not time-sensitive (e.g., without strict requirements or preferences regarding latency), where some level of delay for transmitting this type of data is acceptable. In some embodiments, the non-deterministic data may include the Best Effort (BE) data, which is defined by the IEEE 802.11be standard. Examples of non-deterministic data may include data generated for web browsing, email, non-live media uploading/downloading, and storage synchronization. As used herein, “deterministic” data may refer the type of data that is time-sensitive (e.g., having strict latency requirements or preferences) and should be delivered within a specified timeframe. In some embodiments, the deterministic data may include the Time-Sensitive (TS) data, which is defined by the IEEE 802.11be standard. Examples of deterministic data may include data generated for online gaming, video conferencing, and/or live streaming, among others.

In some embodiments, the STA MLD 105 may alternatively be referred to as stations (STA), client devices, user devices, mobile devices, and the like. The STA MLD 105 may be any type of device that can connect to a local wireless network (e.g., WiFi) through one or more APs, including but not limited to traditional computing devices such as desktop computers, laptops, servers, tablets, smart phones, and wearable devices, as well as a growing number of Internet of Things (IoT) devices such as smart home devices, fitness trackers, industrial sensors, and the like.

In some embodiments, the AP MLD (e.g., 110-1, 110-2, or 110-3) may be referred to as simply an access point (AP). The AP MLD (e.g., 110-1, 110-2, or 110-3) may be any type of device that can act as an interface between client devices (e.g., a STA MLD) and the network infrastructure.

In the illustrated environment 100, each of the three AP MLDs connects to a wireless LAN controller (WLC) 115. The WLC 115 is a device responsible for managing and controlling wireless network APs or AP MLDs. For example, in some embodiments, the WLC 115 may monitor the load and performance of individual APs. Based on the observed data, the WLC 115 may distribute client connections evenly across the APs to prevent any single AP from being overloaded. Additionally, in some embodiments, the WLC 115 may facilitate seamless roaming between different APs within the wireless network. When a client device (e.g., a STA MLD) moves from the coverage area of one AP to another, the WLC 115 may coordinate the handoff and connection processes. Furthermore, in some embodiments, the WLC 115 may handle client authentication processes, manage security policies, and continuously monitor the health, performance, and status of the APs and client devices to provide real-time reporting and alerts.

In the illustrated environment 100, the WLC 115 connects the AP MLDs to a broader network 125 (e.g., the Internet or another local network) In some embodiments, the WLC 115 may route and forward data packets between the wireless network and other parts of the network. In some embodiments, when different types of traffic arrive, the WLC 115 may recognize and prioritize certain types of packets or data streams to ensure that the applications that are time-sensitive or critical to business operations function smoothly, as describe in more detail below.

In the illustrated environment 100, the network 125 may include connections to the Internet or other local wireless networks. For example, in some embodiments, the network 125 may provide connections to the Internet, enabling the wireless devices to access global resources and services. Through such connections, the users within the network (e.g., using STA MLD 105) may engage in various online activities, such as browsing websites, using cloud services, communicating via email or live chat, watching videos, accessing remote servers and databases, and the like. In some embodiments, the network 125 may provide connections to other wireless networks. This interconnectivity may enable the wireless devices (e.g., AP MLDs 110-1, 110-2, and 110-3, STA MLD 105) to communicate with devices in other networks, and therefore facilitate seamless data exchange and cooperation.

In some embodiments, the environment 100 may or may not include the WLCs 115. In such scenarios, the AP MLDs 110-1, 110-2, and 110-3 may directly connect to the network 125. Without the WLC 115, the AP MLDs may handle many functions that are otherwise centralized by the WLC, such as client authentication, security, quality of service (QOS) management, and potential load balancing. The decentralized model may be chosen for smaller or simpler network environments where centralized control is not necessary, and may provide more flexibility compared with a centralized approach, as each AP operates independently of a central controller and can make decisions on its local environment and configuration.

When the STA MLD 105 is actively engaged in data exchange with the AP MLD 110-1 via a primary link, there may be situations where deterministic data (also referred to in some embodiments as preemptive data) arrives and is ready to be transmitted. The deterministic data may either be destined for the STA MLD 105 from another device via the AP MLD 110-1 (e.g., downlink traffic), and/or transmitted by STA MLD 105 to another device via the AP MLD 110-1 (e.g., uplink traffic). Under such situations, in some embodiments, the devices responsible for transmitting the deterministic data (e.g., the AP MLD 110-1 for downlink traffic, or the STA MLD 105 for uplink traffic) may determine to prioritize the deterministic traffic (due to its time-sensitive nature). To achieve this, the transmitting device may temporarily preempt the on-going data transmission to a secondary link (e.g., from the same AP or a different AP), and transmit the deterministic data via the primary link. The preemption operations allow the deterministic data to be exclusively transmitted over the primary link, while ensuring the ongoing regular data transmission (e.g., non-deterministic traffic) continue without delay on the secondary link. In some embodiments, once the deterministic data has been successfully transmitted, the transmitting device may then resume the previously preempted non-deterministic data traffic back to the primary link.

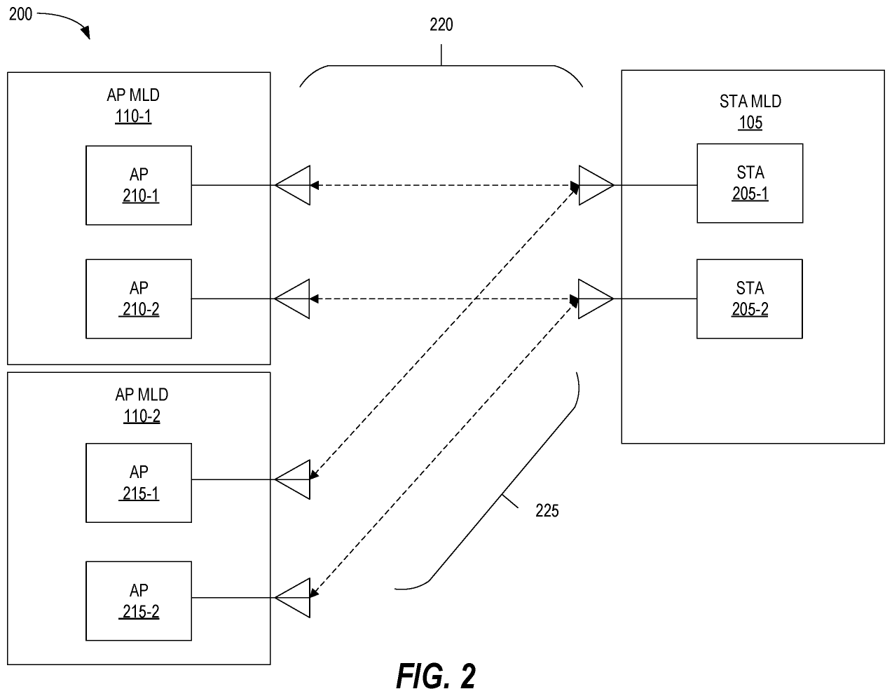

FIG. 2 depicts an example environment 200 for multi-link operation (MLO), according to some embodiments of the present disclosure. In the illustrated environment 200, the STA MLD 105 is communicatively coupled with the AP MLD 110-1 via a set of links 220, and the STA MLD 105 is communicatively coupled with the AP MLD 110-2 via a set of links 225. Each of the AP MLDs comprises two radio interfaces. For example, AP MLD 110-1 comprises two radio interfaces, AP 210-1 and AP 210-2, each having a unique Basic Service Set Identifier (BSSID) for low-level networking. AP MLD 110-2 comprises two radio interfaces, AP 215-1 and AP 215-2, each having a unique Basic Service Set Identifier (BSSID) for low-level networking. The STA MLD 105 also comprises two radio interfaces, STA 205-1 and STA 205-2. Each interface of the STA MLD 105 has a unique Medium Access Control (MAC) address for low-level, hardware-based networking.

In some embodiments, the links 220 and 225 correspond to wireless connections. In some embodiments, a link (e.g., 220 or 225) exists between each antenna of the AP MLDs (e.g., 110-1, 110-2) and each antenna of the STA MLD (e.g., 105). In the illustrated example, links 220 exist between each AP 210 and a corresponding STA 205, links 225 exist between each AP 215 and a corresponding STA 205. For example, the AP 210-1 may have one or more links 220 connecting it to the STA 205-1, each link having a unique link ID. The AP 210-2 may have one or more links 220 connecting it to the STA 205-2, each link having a unique link ID. Similarly, the AP 215-1 may have one or more links 225 connecting it to the STA 205-1, each link having a unique link ID, and the AP 215-2 may have one or more links 225 connecting it to the STA 205-2, each link having a unique link ID. In some embodiments, each linked AP/STA pair may operate at a different frequency, as compared to other AP/STA pairs. For example, the AP 210-1 and STA 205-1 may use a first frequency band (e.g., 2.4 GHz), while AP 210-2 and STA 205-2 use a second band (e.g., 5 GHZ). The AP 215-1 and STA 205-1 may use the first frequency band (e.g., 2.4 GHZ), while AP 215-2 and STA 205-2 use the second band (e.g., 5 GHz).

The AP MLDs 110-1 and 110-2, and STA MLD 105 are generally representative of any device capable of performing multi-link operations (MLO). Although the AP MLDs 110-1, 110-2 and STA MLD 105 are depicted for conceptual clarity, in some embodiments, the MLO may be performed between any MLDs, including multiple AP MLDs, multiple STA MLDs, or any other MLDs. In the illustrated example, the AP MLDs 110-1 and 110-2 are depicted as each having two radio interfaces, in some embodiments, the AP MLD may use any number of APs (e.g., 210 or 215) (including one). In the illustrated example, STA MLD 105 is depicted as having two radio interfaces, in some embodiments, the STA MLD 105 may use any number of STAs 205 (including one).

As illustrated, the APs (e.g., 210-1, 210-2, 215-1, or 215-2) each have one antenna, in some embodiments, each AP (e.g., 210-1, 210-2, 215-1, or 215-2) may have any number of antennas. Similarly, though the STAs (e.g., 205-1, 205-2) each have one antenna in the illustrated example, in some embodiments, each STA (e.g., 205-1, 205-2) may have any number of antennas.

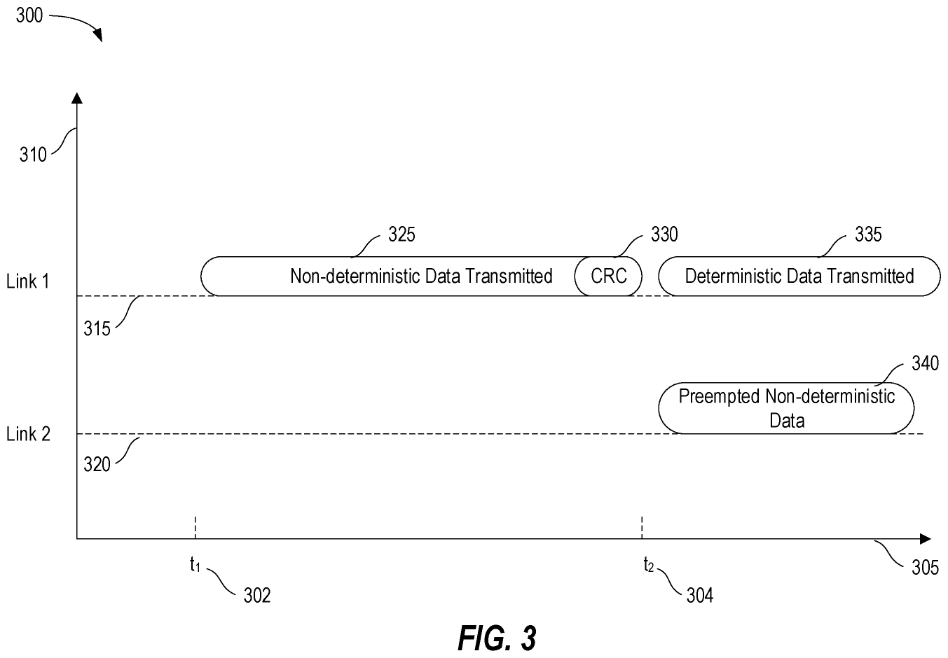

While the STA MLD 105 is actively exchanging data with the AP MLD 110-1 via a first link 220 (e.g., established between AP 210-1 and STA 205-1), the need for deterministic data transmission may arise. For example, suppose uplink deterministic data reaches or is generated by the STA MLD 105 and is ready to be transmitted to another client device via the AP MLD 110-1. Alternatively or additionally, deterministic data, originating from another device, may reach the AP MLD 110-1 and may be ready to be transmitted the STA MLD 105. To ensure the optimal (or at least improved) transmission of both the regular (or non-deterministic) and the deterministic data, the transmitting device (which is preparing to transmit the deterministic data) may reroute the ongoing regular (e.g., non-deterministic) data transmission from the first link to a second link, leaving the first link exclusively for deterministic data transmission. In some embodiments, the second link may be the link set up between different AP/STA pairs associated the same AP (e.g., the link between AP 210-2 and STA 205-2). In some embodiments, the second link may refer to the link established with a different AP (e.g., the link between AP 215-2 and STA 205-2). FIG. 3 depicts a time diagram 300 for handling preemptions between different links, according to some embodiments of the present disclosure.

In the illustrated time diagram 300, the horizontal axis 305 represents time, moving from left to right, with specific timestamps (e.g., t1, and t2) indicating the arrival or occurrence of different types of traffic. The vertical axis 310 is divided into two sections, representing a first link 315 (labeled as “Link 1” in the illustrated example) and a second link 320 (indicated as “Link 2” in the illustrated example). In some embodiments, Link 1 and Link 2 may represent connections established between the same STA MLD and AP MLD (e.g., links 220 between AP MLD 110-1 and STA 105). In some embodiments, Link 1 and Link 2 may operate on different frequency bands (e.g., 2.4 GHz, 5 GHZ, or 6 GHZ) and/or use different communication channels. In some embodiments, Link 1 and Link 2 may represent connections established between one STA MLD and multiple AP MLDs (e.g., links 220 between AP MLD 110-1 and STA 105, and links 225 between AP MLD 110-2 and STA 105). In some embodiments, Link 1 and Link 2 may operate on the same frequency bands (e.g., 2.4 GHZ, 5 GHZ, or 6 GHZ) between different AP MLDs.

In the illustrated time diagram 300, the timestamp 302 (labeled “t1” in the illustrated example) represents the time when non-deterministic data arrives and/or is ready to be transmitted. As used herein, data “arriving” can generally correspond to any time when data is ready for transmission, such as when it is received from another component or system, when it is generated and ready for transmission, and the like. The horizontal bar 325 represents the transmission of the non-deterministic data over Link 1, starting at t1 and extending to the right. The timestamp 304 “t2” represents the time when deterministic data arrives and is ready to be transmitted. At t2, the horizontal bar 325, which represents the transmission of the non-deterministic data over the first link 315, is interrupted (also referred to as preempted in some aspects), and a Cyclic Redundancy Check (CRC) value 330 is appended to the interrupted transmission 325. The CRC value 330, appended to the interrupted non-deterministic data, indicates that the integrity check mechanism has been applied to the data. In some embodiments, the CRC value 330 may be used by the receiving device (e.g., STA MLDs or AP MLDs) within the network to verify the validity of the portion of non-deterministic data transmitted up to the time of preemption (depicted by the horizontal bar 325). The CRC value 330 ensures that the integrity of the non-deterministic data is maintained, even in the complicated MLO where the transmission of non-deterministic data is interrupted and/or preempted from one link (e.g., Link 1) to another link (e.g., Link 2).

In the illustrated example, after the deterministic data is ready for transmission at t2, the transmission of the deterministic data is initiated over the first link 315 (depicted by the horizontal bar 335). Simultaneously, the transmission of the preempted non-deterministic data is rerouted from the first link 315 to the second link 320 (as represented by the horizontal bar 340), starting at t2 and extending to the right.

In some embodiments, the transmitting device may send a message (or a tag) to the receiving device, notifying the receiving device where to expect the remaining portion of the non-deterministic data (e.g., after the transmission of the non-deterministic data is interrupted and/or preempted from Link 1 to Link 2). In some embodiments, the message (or the tag) may include information about the new link (also referred to in some embodiments as the destination link), such as the new link's identifier, the priority of the preempted data, and other relevant detail to smooth the preemption process.

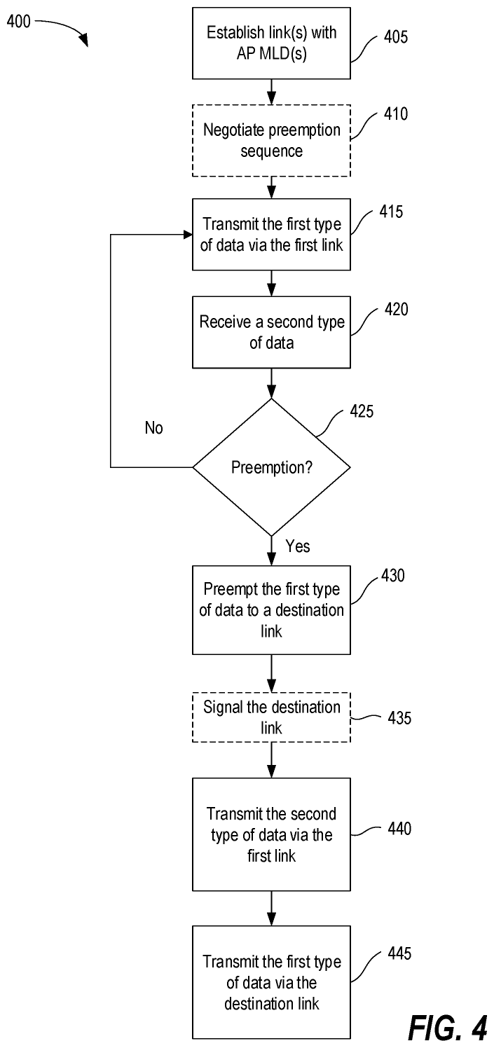

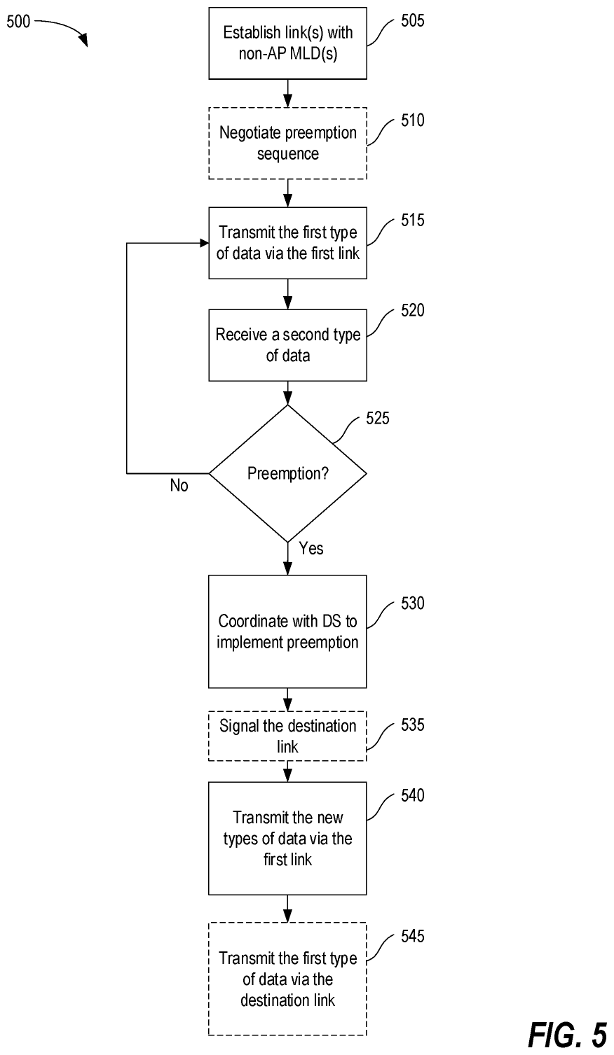

In some embodiments, the system may not need to send a specific message (or a tag) to manage the preemption of traffic. Instead, the AP MLD (e.g., 110-1 of FIG. 2) and the STA MLD (e.g., 105 of FIG. 2) may establish the preemption sequence during the association phase or at another time, as described in more detail in FIGS. 4 and 5.

FIG. 4 depicts an example method 400 for coordinating uplink data transmissions across multiple links by a station multi-link device (STA MLD), according to some embodiments of the present disclosure. In some embodiments, the method 400 may be performed by a client device that supports MLO, such as the STA MLD 105 of FIG. 2.

At block 405, the STA MLD (e.g., 105 of FIG. 2) establishes one or more links (e.g., 220, and 225 of FIG. 2) with one or more AP MLDs (e.g., 110-1, and 110-2 of FIG. 2). The process of establishing links with AP MLDs may include several steps. In some embodiments, the STA MLD may start by scanning available APs within its range. The scanning may include active scanning and passive scanning. In active scanning, the STA MLD may send probe requests to discover available APs within its range. The request may contain information about the capabilities of the STA MLD, its preferred network, and/or configurations. The APs that receive the probe request may respond with probe responses, providing information about their capabilities, supported features, network load, or other relevant data. In passive scanning, the STA MLD may listen for beacon frames broadcasted by the APs to advertise their presence.

Once the scanning is complete, the STA MLD may evaluate the information gathered from each AP to identify suitable APs for connection. The evaluation may consider factors like signal strength, network load, supported data rates, and other relevant operational parameters. After the suitable APs are identified, the STA MLD may then associate with the selected APs, initiating the authorization and association processes. The authorization process may include exchanging credentials or cryptographic information to validate each other's identity. The association process may include finalizing the connection parameters, setting up links, and configuring multi-link operations.

In some embodiments, as illustrated at block 410, the STA MLD and each of its connected AP MLDs may negotiate the preemption sequence during the association time. For example, when the STA MLD (e.g., 105 of FIG. 2) is connecting to the AP MLD (e.g., 110-1 of FIG. 2) during the association phase, the AP MLD (or a WLC) may advertise specific preemption rules and sequences that will dictate how preemption will be handled to its client devices (e.g., STA MLDs). The preemption rules may include priorities for different types of data (e.g., BE or TS), and/or the specific process that will be followed if preemption is necessary. The preemption sequence may outline how traffic will be rerouted when higher-priority data arrives and needs to be transmitted immediately. During regular communication, the AP MLD (e.g., 105 of FIG. 2) and STA MLD (e.g., 110-1 of FIG. 2) follow the agreed-upon preemption sequence without the need to exchange specific message (or tags). In some embodiments, the preemption sequence may be defined on a per-client basis and proposed by the client device (e.g., STA MLD 105 of FIG. 2) during the association time.

In some embodiments, the preemption sequence may be defined as a specific order of links, such as {Link_A, Link_B, Link_C}, that will be followed when preemption is needed. If higher-priority frame (e.g., a TS frame) arrives while Link A is being used to transmit a BE frame, the system refers to the predefined sequence. According to the sequence {Link_A, Link_B, Link_C}, the ongoing BE frame on Link_A will be preempted, and the remaining portion of the frame will be transmitted over Link_B (while the TS frame(s) are transmitted via Link_A). If preemption is also required on Link_B (e.g., because additional higher priority data arrives for immediate transmission), the BE traffic on Link_B will be moved to Link_C (allowing the new deterministic data to be transmitted via Link_B), following the predefined preemption sequence. Additionally, in some embodiments, if preemption is further required on Link_C, the BE traffic on Link_C may be moved to Link_A, forming a rotating sequence within the defined order of links. In some embodiments, if preemption on Link_C is required, the BE traffic may be paused until one or more of the other links become available (rather than potentially interrupting deterministic traffic).

At block 415, the STA MLD receives a first type of data for uplink transmission. The first type of data may include various data packets that have been collected and organized according to specific criteria like sequence and source, and may have a specific priority category, such as Best Effort (BE) or Time-Sensitive (TS). The first type of data may be generated by a specific application running on the STA MLD (such as a web browser, a video conferencing software, an email box, a gaming application, or any other software that requires network communication), or may be received for uplink from another device or component. The STA MLD then begins transmitting the first type of data via the first link (e.g., Link 1 of FIG. 3) established with its associated AP MLD (e.g., the primary link designated in the link preemption agreement). In some embodiments, the first type of data may also be referred to as the ongoing transmitted data, and/or the first-received data.

At block 420, while transmitting the first type of data via the first link, the STA MLD receives a second type of data for uplink transmission. In some embodiments, the second type of data may have a higher priority compared to the ongoing transmitted data. For example, the ongoing transmitted data may include BE frames, which are typically handled with standard priority, while the newly received data may include TS frames, which must be transmitted without delay.

At block 425, the STA MLD evaluates both the ongoing transmitted data and the second type of data to determine whether preemption is necessary. As used herein, the preemption may refer to the process of interrupting the ongoing transmission of the lower-priority data on the first link to provide resources to the higher-priority data, and resuming the transmission of the lower-priority data on another link.

The evaluation process may include recognizing and comparing the priorities of the ongoing transmitted data and the second type of data. In some embodiments, the priority may be identified by examining the header or specific identifier included within each frame, or a queue of data frames. In some embodiments, the STA MLD may perform real-time pattern analysis to discern the nature of the data received. The analysis may consider a variety of factors, such as the pattern of data, timing, and requirements of the source applications, among others. If it is determined that the second type of data has a higher priority than the ongoing data transmission, preemption may be used. To determine that preemption is necessary and/or should be implemented, the STA MLD may further evaluate the potential impact of preemption on both types of data and the overall network performance. A variety of factors may be considered, such as the overall load on the network, the quality of the established links, the availability of alternative paths for transmission, the predefined preemption rules, the QoS requirements, the energy consumption, and other relevant information affecting the network performance. Based on the comprehensive analysis, the STA MLD may determine whether to implement the preemption.

If it is determined to implement the preemption, the method 400 proceeds to block 430, where the STA MLD preempts the first type of data (also referred to in some embodiments as the first-received data or the ongoing transmitted data) to another link (also referred to in some embodiments as the destination link) (e.g., Link 2 of FIG. 3). If it is determined not to implement the preemption, the method 400 returns to block 415, where the STA MLD continues to transmit the first type of data via the first link (e.g., Link 1 of FIG. 3). Once the first data transmission is complete on the first link, the newly received data may similarly be transmitted via this first link.

In some embodiments, the first link and the destination link may represent connections established between different AP/STA pairs within the same STA MLD and AP MLD. For example, the first link may refer to the link 220 established between AP 210-1 and STA 205-1, as illustrated in FIG. 2, which may use the first frequency band (e.g., 5 GHZ). The destination link may refer to the link 220 established between AP 210-2 and STA 205-1, as illustrated in FIG. 2, which may use the second frequency band (e.g., 2.4 GHZ). In some embodiments, the first link and the destination link may represent connections established between different AP/STA pairs between one STA MLD and multiple AP MLDs within the same MLO groups. For example, the first link may refer to the link 220 established between AP 210-1 and STA 205-1, as illustrated in FIG. 2, and the destination link may refer to the link 225 established between AP 215-2 and STA 205-2, as illustrated in FIG. 2. In some embodiments, in order to smooth the link switching process (e.g., reducing time for waking up a different radio), the backup AP MLD (e.g., 110-2 of FIG. 2) may be programmed to enable the destination link using the same frequency band (e.g., 2.4 GHZ, 5 GHZ, or 6 GHZ) or channel close to the first link.

In some embodiments, at block 435, the STA MLD may transmit a message (or a tag) to the AP MLDs, notifying the AP MLDs of the link to which the first type of data is redirected (e.g., the destination link). In some embodiments, when a defined preemption sequence has been negotiated and agreed upon between the STA MLD and its connected AP MLDs, the message (or tag) containing the information about the destination link may not be sent.

At block 440, the STA MLD transmits the second type of data via the first link. At block 445, the STA MLD transmits the remaining portion of the preempted data (also referred to in some embodiments as the first type of data, or the first-received data) via the destination link.

FIG. 5 depicts an example method 500 for coordinating downlink data transmissions across multiple links, according to some embodiments of the present disclosure. In some embodiments, the method 500 may be performed by an access point that supports MLO, such as AP MLD 110-1, or 110-2 of FIG. 2. In some embodiments, the method 500 may be performed by WLC that manages multiple AP MLDs, such as the WLC 115 of FIG. 1.

At block 505, the AP MLD (e.g., 110-1 of FIG. 2) establishes one or more links (e.g., 220 of FIG. 2) with a STA MLD (e.g., 105 of FIG. 2). In some embodiments, the AP MLD may first broadcast beacon frames to potential client devices, and/or respond to probe requests sent by potential client devices. The beacon frames and/or the probe responses may include the network information of the AP MLD. After the STA MLD is identified, the AP MLD and the STA MLD may then go through an authentication process to validate each other's identities. Once authenticated, the AP MLD and the STA MLD may be associated, establishing one or more links (e.g., 220 of FIG. 2) between the AP/STA pairs within the two devices.

In some embodiments, as illustrated at block 510, the AP MLD and the connected STA MLD may negotiate the preemption sequence during the association process. As discussed above, in some embodiments, the defined preemption sequence may be defined and/or advertised by either the AP MLD or the STA MLD, and agreed upon by both parties during the association phase. During regular communication, the AP MLD and STA may follow the agreed-upon preemption sequence without the need to exchange specific messages (or tags). In some embodiments, the preemption sequence may be defined as a specific order of links, such as {Link_A, Link_B, Link_C}, describing how traffic is moved between links based on priority. In some embodiments, the specific order of links {Link_A, Link_B, Link_C} represents that the AP MLD preempts the traffic from Link A to Link B, from Link B to Link C, and from Link C back to Link A (in a rotating sequence).

At block 515, the AP MLD receives a first type of data from the connected network (e.g., 125 of FIG. 1) for downstream transmission to the STA MLD. In some embodiments, the first type of data may be requested by a specific application running on the STA MLD, and may have a specific priority category, such as BE or TS. The AP MLD transmits the first type of data to the STA MLD via the first link (e.g., Link 1 of FIG. 3) established between the AP MLD and the STA MLD. In some embodiments, the first type of data may also be referred to as the ongoing transmitted data, and/or the first-received data.

At block 520, the AP MLD receives a second type of data (e.g., BE or TS) from the connected network (e.g., 125 of FIG. 1) for downstream transmission to the STA MLD. In some embodiments, the second type of data may have a higher priority compared to the first type of data.

At block 525, the AP MLD determines whether to implement the preemption, such as by comparing the priorities of the first type of data and second type of data, and/or evaluating the potential impact of preemption on both types of data and the overall network performance. In some embodiments, preemption may be implemented when the second type of data has a higher priority than the first type of data, and the potential impact of preemption is negligible. If it is determined to implement the preemption, the method 500 proceeds to block 530, where the AP MLD coordinates with the DS (e.g., 120 of FIG. 1) to preempt the first type of data that is being transmitted via the first link (e.g., Link 1 of FIG. 3) to another link (also referred to in some embodiments as the destination link) (e.g., Link 2 of FIG. 3). Otherwise, the method 500 returns to block 515, where the AP MLD continues to transmit the first type of data via the first link (e.g., Link 1 of FIG. 3).

In some embodiments, as illustrated at block 535, the AP MLD may transmit a message (or a tag) to the STA MLD, notifying the STA MLD of the link (e.g., the destination link) it may expect to receive the remaining portion of the first type of data. In some embodiments, during the association phase, a predefined preemption sequence may be negotiated and agreed upon between the AP MLD and its connected STA MLD. In this configuration, the message (or tag) containing the information about the destination link may not be sent.

At block 540, the AP MLD transmits the second type of data via the first link (e.g., Link 1 of FIG. 3). In some embodiments, the first link (e.g., Link 1 of FIG. 3) and the destination link (e.g., Link 2 of FIG. 3) may connect different AP MLDs to the STA MLD. For example, the first link (e.g., 220 of FIG. 2) may be established between the AP 210-1 and STA 205-1, connecting AP MLD 110-1 to STA MLD 105, and the destination link (e.g., 225 of FIG. 2) may be established between the AP 215-1 and STA 205-2, connecting AP MLD 110-2 to STA MLD 105. Under such circumstances, the AP MLD 110-1 may transmit the second type of data via the first link to the STA MLD 105, and the AP MLD 110-2 (e.g., as the backup AP) may transmit the remaining portion of the preempted data (also referred to in some embodiments as the first type of data, the ongoing transmitted data, or the first-received data) via the destination link to the STA MLD 105. In some embodiments, the destination link may be selected based on the closeness of its frequency band to that of the first link. For example, several links (e.g., 225 of FIG. 2) have been established between the backup AP MLD 110-2 and STA MLD 105, working on different frequency bands. If it is determined that the first link uses the 2.5 GHz frequency band, the link that also works on 2.5 GHZ, among all links connecting the STA MLD 105 to the backup AP MLD 110-2, may be selected as the destination link.

In some embodiments, both the first link (e.g., Link 1 of FIG. 3) and the destination link (e.g., Link 2 of FIG. 3) may be established between the same STA MLD and AP MLD and operate on different channels or frequencies. For example, the first link may refer to the link established between AP 210-1 and STA 205-1, as illustrated in FIG. 2, which may use a first frequency band (e.g., 5 GHZ). The destination link may refer to the link established between AP 210-2 and STA 205-1, as illustrated in FIG. 2, which may use a second frequency band (e.g., 2.4 GHZ). Under such circumstances, as illustrated at block 545, the AP MLD 110-1 may transmit the remaining portion of the preempted data (also referred to in some embodiments as the first type of data, the ongoing transmitted data, or the first-received data) via the destination link to the STA MLD 105.

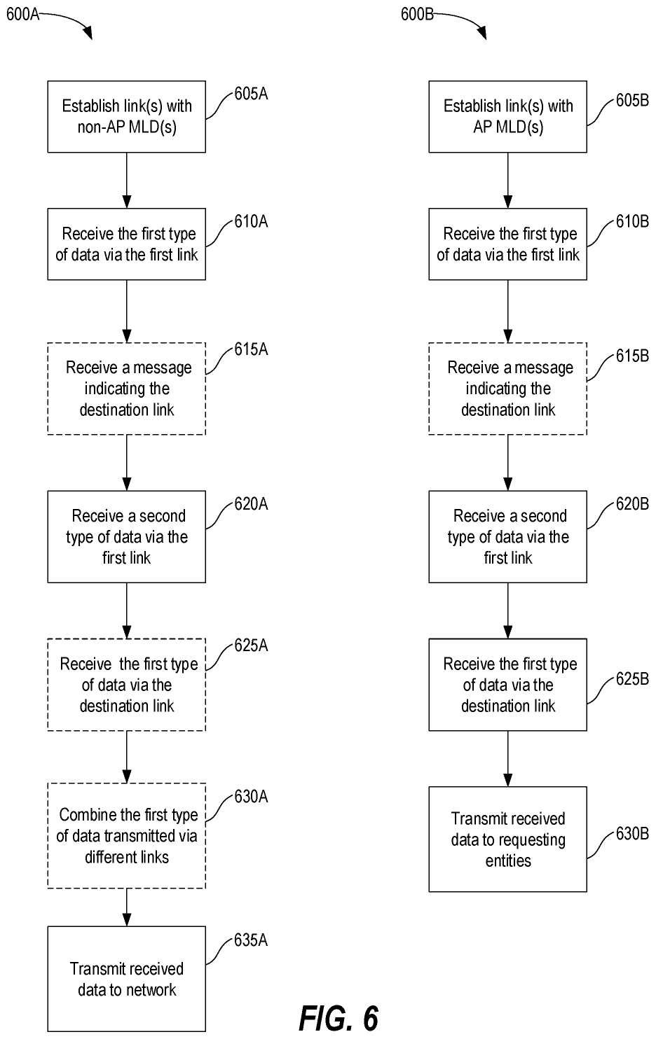

FIG. 6 depicts example methods for receiving data transmissions across multiple links, according to some embodiments of the present disclosure. In this figure, two example methods (e.g., 600A and 600B) are depicted. The example method 600A is related to receiving uplink data transitions across multiple links. In some embodiments, the method 600A may be performed by an access point that supports MLO, such as AP MLD 110-1, or 110-2 of FIG. 2. In some embodiments, the method 600A may be performed by a WLC that manages multiple AP MLDs, such as the WLC 115 of FIG. 1.

The method 600A starts at block 605A, where an AP MLD (e.g., 110-1 of FIG. 2) establishes one or more links (e.g., 220 of FIG. 2) with a STA MLD (e.g., 105 of FIG. 2). In some embodiments, the STA MLD is transmitting a first type of data (e.g., received from an application running on it) to the network via the AP MLD.

At block 610A, the AP MLD receives the first type of data from the STA MLD via the first link (e.g., Link 1 of FIG. 3). In some embodiments, as illustrated at block 615A, the AP MLD may receive a message (or a tag) indicating the link to which the first type of frames should be moved (e.g., the destination link).

At block 620A, the AP MLD receives a second type of data from the STA MLD via the first link. In some embodiments, the first link and the destination link are both established between the same access point (e.g., 110-1 of FIG. 2) and client device (e.g., 105 of FIG. 2). The two links may operate on different channels or frequencies, allowing for parallel transmission paths. As such, as illustrated at block 625A, the AP MLD (e.g., 110-1 of FIG. 2) may receive the remaining portion of the first type of data via the destination link.

In some embodiments, the first link may connect the STA MLD (e.g., 105 of FIG. 2) to the current AP MLD (e.g., 110-1 of FIG. 2), the destination link may connect the STA MLD (e.g., 105 of FIG. 2) to another AP MLD (e.g., 110-2 of FIG. 2) within the MLO group. As such, the backup AP MLD (e.g., 110-2 of FIG. 2) may receive the remaining portion of the first type of data via the destination link.

In some embodiments, as illustrated at block 630A, the AP MLD (e.g., 110-1 of FIG. 2) may combine the portion of the first type of data transmitted via the first link with the portion of the first type of data transmitted via the destination link.

In some embodiments, when the destination link connects the STA MLD to a backup AP MLD (e.g., 110-2 of FIG. 2), the current AP MLD (e.g., 110-1 of FIG. 1) may contact the backup AP MLD to coordinate the handling of the first type of data. In some embodiments, the coordination may include sharing the partially transmitted data, the sequence, and other necessary information to ensure the backup AP MLD can accurately combine the fragmented data. In some embodiments, the reassembly process for combining the fragmented data transmitted via different links into the correct order may be performed by a WLC.

At block 635A, the AP MLD transmits the received different types of data (e.g., the first type of data, partially or in a combined order, and/or the second type of data) to the network (e.g., 125 of FIG. 1).

The example method 600B is related to receiving downlink data transitions across multiple links. In some embodiments, the method 600B may be performed by a client device that supports MLO, such as STA MLD 105 of FIG. 2.

The method 600B begins at block 605B, where an STA MLD (e.g., 105 of FIG. 2) establishes one or more links (e.g., 220 of FIG. 2) with an AP MLD (e.g., 105 of FIG. 2). In some embodiments, the AP MLD is transmitting a first type of data, received from the network (e.g., 125 of FIG. 1), to the STA MLD. In some embodiments, the first type of data may be requested by and/or destined for an application running on the STA MLD, and may have a specific priority category based on the type of the application. For example, if the requesting or destination application is a web browser, which does not require real-time data transmission and can tolerate some delays, the first type of data may be classified as BE data. In contrast, if the requesting or destination application involves live conferencing, video streaming, or other time-sensitive activities that require data transmission with minimal delay, the first type of data may be classified as TS data (or even a higher priority category), reflecting the nature of timely data delivery for these applications.

At block 610B, the STA MLD (e.g., 105 of FIG. 2) receives a first type of data from the AP MLD (e.g., 110-1 of FIG. 2) via the first link (e.g., Link 1 of FIG. 3). In some embodiments, as illustrated at block 615B, the STA MLD may receive a message (or a tag) from the transmitting device, the AP MLD, which indicates the destination link (e.g., Link 2 of FIG. 3) to which the transmission of the first type of data should be rerouted.

At block 620B, the STA MLD receives a second type of data from the AP MLD via the first link (e.g., Link 1 of FIG. 3). At block 625B, the STA MLD receives the remaining portion of the first type of data via the destination link (e.g., Link 2 of FIG. 3). In some embodiments, the first link and the destination link may refer to the connections established between different radio interfaces (e.g., AP/STA pairs) within the same access point and client device. For example, the first link may refer to the link established between AP 210-1 and STA 205-1, and the destination link may refer to the link established between AP 210-2 and STA 205-2. The first link and destination link may operate on different frequency bands (e.g., 2.4 GHZ, 5 GHZ, 6 GHZ), and represent separate communication paths. The STA MLD 105 may receive the second type of data via the first link, and receive the remaining portion of the first type of data via the destination link.

In some embodiments, a client device may connect simultaneously to multiple access points through different radio interfaces (e.g., AP/STA pairs). In this configuration, the first link may refer to the link (e.g., 220 of FIG. 2) established between AP 210-1 and STA 205-1, and the destination link (e.g., 225 of FIG. 2) may refer to the link established between AP 215-2 and STA 205-2. As such, after the preemption, the STA MLD 105 may receive the second type of data via the first link from AP MLD 110-1, and receive the remaining portion of the first type of data via the destination link from AP MLD 110-2 (also referred to in some embodiments as the backup AP MLD). In some embodiments, the first link and the destination link may operate on the same frequency band. In some embodiments, the destination link may be selected based on the closeness of its frequency band to that of the first link. This approach may help to minimize the impact on signal characteristics and/or reduce the need for significant reconfiguration, thereby improving the overall performance of the preemption.

At block 630B, the STA MLD processes and transmits the received data to the appropriate requesting or destination entities. In some embodiments, the requesting entities may include an end device or an application that requests and/or receives the downstream traffic. In some embodiments, the received data may include the first types of data (e.g., having a relatively lower priority), and/or the second type of data (e.g., having a relatively higher priority). In some embodiments, the STA MLD may reassemble the fragmented data (e.g., the first type of data) in the correct order, and forward the reassembled data to the corresponding end device or application.

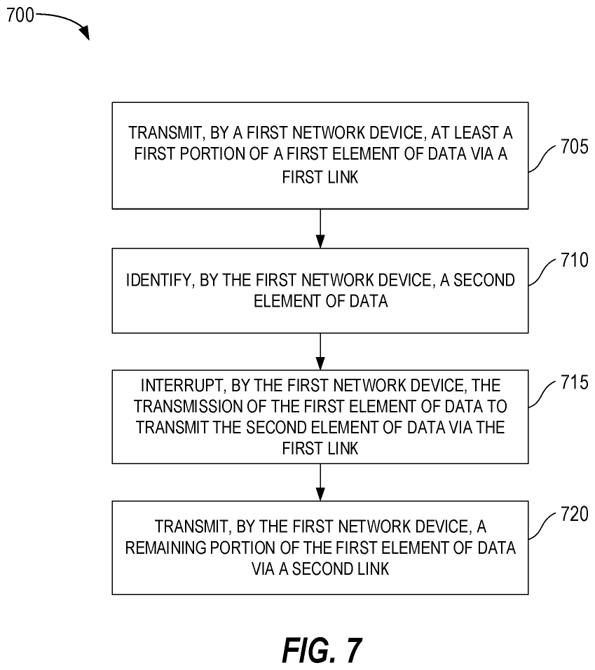

FIG. 7 is a flow diagram depicting an example method 700 for traffic coordination and preemption in MLO, according to some embodiments of the present disclosure.

At block 705, a first network device transmits at least a first portion of a first element of data (e.g., 325 of FIG. 3) via a first link (e.g., Link 1 of FIG. 3). In some embodiments, the first network device may comprise one of an access point (AP) (e.g., AP MLDs 110-1, 110-2, and 110-3 of FIG. 1, AP MLDs 110-1 and 110-2 of FIG. 2), an client device (e.g., STA MLD 105 of FIGS. 1 and 2), or a WLC (e.g., WLC 115 of FIG. 1).

At block 710, the first network device identifies a second element of data. In some embodiments, the second element of data (e.g., TS data) comprises deterministic data that has a higher transmission priority than the first element of data (e.g., BE data).

At block 715, the first network device interrupts the transmission of the first element of data to transmit the second element of data (e.g., 335 of FIG. 3) via the first link (e.g., Link 1 of FIG. 3).

At block 720, the first network device transmits a remaining portion of the first element of data (e.g., 340 of FIG. 3) via a second link (e.g., Link 2 of FIG. 3). In some embodiments, the first and second links connect the first network device to a second network device. In some embodiments, the second network device may comprise one of an access point (AP) (e.g., AP MLDs 110-1, 110-2, and 110-3 of FIG. 1, AP MLDs 110-1 and 110-2 of FIG. 2), or a client device (e.g., STA MLD 105 of FIGS. 1 and 2).

In some embodiments, the method 700 may further comprise transmitting, by the first network device, at least one of a cyclic redundancy check (CRC) (e.g., 330 of FIG. 3), or a tag indicating the second link (e.g., Link 2 of FIG. 3), to the second network device via the first link (e.g., Link 1 of FIG. 3). In some embodiments, the method 700 may further comprise communicating, by the first network device and to the second network device, a defined preemption sequence between the first link and the second link.

In some embodiments, the first network device may comprise a station multi-link device (STA MLD) (e.g., STA MLD 105 of FIG. 2), the first link connects the STA MLD to a first access point multi-link device (AP MLD) (e.g., AP MLD 110-1 of FIG. 2), and the second link connects the STA MLD to a second AP MLD (e.g., AP MLD 110-2 of FIG. 2). In some embodiments, the second AP MLD (e.g., AP MLD 110-2 of FIG. 2) may transmit the remaining portion of the first element of data (e.g., 340 of FIG. 3) to the first AP MLD (e.g., AP MLD 110-1 of FIG. 2). In some embodiments, the first AP MLD (e.g., AP MLD 110-1 of FIG. 2), upon receiving the remaining portion of the first element of data (e.g., 340 of FIG. 3), may combine the remaining portion (e.g., 340 of FIG. 3) and the first portion of the first element of data (e.g., 325 of FIG. 3), and transmit the first element of data to a destination. In some embodiments, the first (e.g., Link 1 of FIG. 3) and second links (e.g., Link 2 of FIG. 3) may operate on the same frequency band (e.g., 2.4 GHz, 5 GHZ, or 6 GHZ).

In some embodiments, the first network device may comprise a first access point multi-link device (AP MLD) (e.g., AP MLD 110-1 of FIG. 2), the first link connects the first AP MLD to a station multi-link device (STA MLD) (e.g., STA MLD 105 of FIG. 2), and the second link connects a second AP MLD (e.g., AP MLD 110-2 of FIG. 2) to the STA MLD. In some embodiments, the method 700 may further comprises transmitting, by the first network device (e.g., AP MLD 110-1 of FIG. 2), the remaining portion of the first element of data (e.g., 340 of FIG. 3) via the second link (e.g., Link 2 of FIG. 3) comprises transmitting the remaining portion of the first element of data to the second AP MLD, where the second AP MLD forwards the remaining portion of the first element of data to the STA MLD via the second link. In some embodiments, the first (e.g., Link 1 of FIG. 3) and second links (e.g., Link 2 of FIG. 3) may operate on the same frequency band (e.g., 2.4 GHz, 5 GHz, or 6 GHZ).

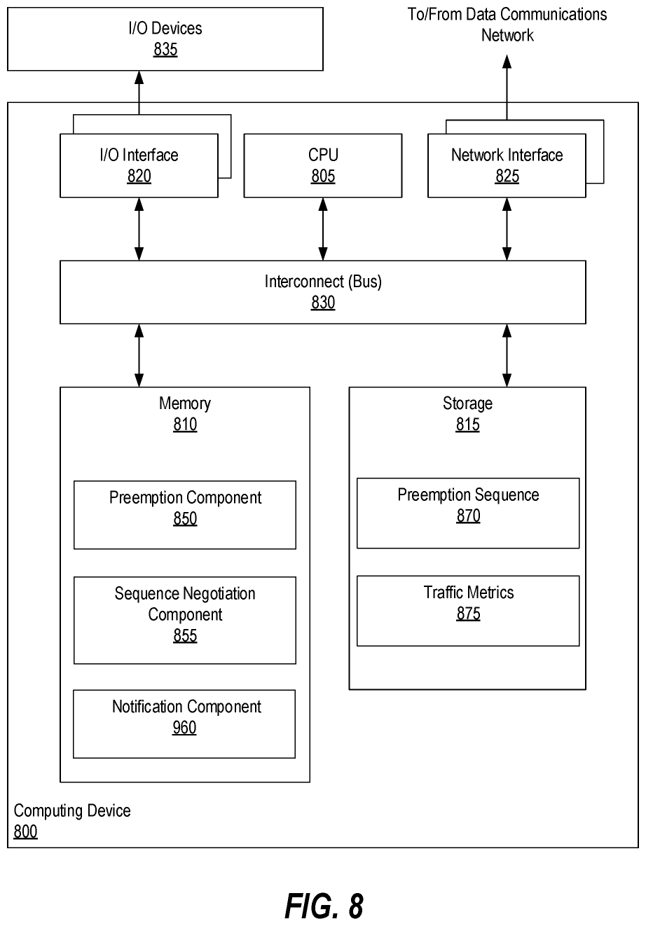

FIG. 8 depicts an example computing device 800 configured to perform various aspects of the present disclosure, according to one embodiment. Although depicted as a physical device, in embodiments, the computing device 800 may be implemented using virtual device(s), and/or across a number of devices (e.g., in a cloud environment). In one embodiment, the computing device 800 may correspond to an access point that supports MLO, such as the AP MLDs 110-1, 110-2, and 110-3 of FIG. 1, the AP MLD 110-1, 110-2 of FIG. 2, a client device that supports MLO, such as the STA MLD 105 of FIGS. 1 and 2. In some embodiments, the computing device 800 may correspond to a WLC that manages multiple AP MLDs, such as the WLC 115 of FIG. 1.

As illustrated, the computing device 800 includes a CPU 805, memory 810, storage 815, one or more network interfaces 825, and one or more I/O interfaces 820. In the illustrated embodiment, the CPU 805 retrieves and executes programming instructions stored in memory 810, as well as stores and retrieves application data residing in storage 815. The CPU 805 is generally representative of a single CPU and/or GPU, multiple CPUs and/or GPUs, a single CPU and/or GPU having multiple processing cores, and the like. The memory 810 is generally included to be representative of a random access memory. Storage 815 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 835 (such as keyboards, monitors, etc.) are connected via the I/O interface(s) 820. Further, via the one or more network interfaces 1025, the computing device 1000 can be communicatively coupled with one or more other devices and components (e.g., via a network, which may include the Internet, local network(s), and the like). As illustrated, the CPU 805, memory 810, storage 815, network interface(s) 825, and I/O interface(s) 820 are communicatively coupled by one or more buses 830. The network interface 825 connects to a wireless communication network (e.g., a network following the IEEE 802.11 standard) via one or more antennas.

In the illustrated embodiment, the memory 810 includes a preemption component 850, a sequence negotiation component 855, and a notification component 860, which may perform one or more embodiments discussed above. Although depicted as discrete components for conceptual clarity, in embodiments, the operations of the depicted components (and others not illustrated) may be combined or distributed across any number of components. Further, although depicted as software residing in memory 810, in embodiments, the operations of the depicted components (and others not illustrated) may be implemented using hardware, software, or a combination of hardware and software.

In one embodiment, the preemption component 850 may manage the process of preemption, which involves dynamically interrupting and/or redirecting the ongoing transmission of lower-priority traffic, and facilitating the immediate transmission of higher-priority traffic. For example, the preemption component 850 may evaluate the newly received and ongoing transmitted data to determine their respective priorities. Based on the evaluation, the preemption component 850 may compare the priorities and decide whether preemption is necessary and should be implemented. In some embodiments, to determine whether preemption is necessary, the preemption component 850 may further evaluate the potential impact of preemption on both types of data and the overall network performance. This may include considering factors such as the overall network load, link quality, availability of alternative paths for transmission, and predefined preemption rules, among others. If preemption is determined to be necessary, in some embodiments, the preemption component 850 may interrupt the transmission of lower-priority data on the current link to provide resources to initiate the immediate transmission of the higher-priority data. The preempted data with lower priority may be redirected to another link for transmission. In some embodiments, the preemption component 850 may hold the preempted data in a buffer, and transmit it later without loss. In some embodiments, the preemption component 850 may keep tracking the preemption activities, and generate reports or logs for further network management and/or optimization.

In one embodiment, the sequence negotiation component 855 may engage with connected devices (e.g., AP MLDs and STA MLDs) to define and negotiate the preemption sequence within a network. In some embodiments, the sequence negotiation component 855 may propose a preemption sequence considering various network requirements and constraints, such as bandwidth availability, link quality, existing traffic patterns, priority level of data frames, Quality of Service (QOS) guidelines, energy consumption, and other relevant information/parameters. In some embodiments, after the proposed sequence is created, the sequence negotiation component 855 may transmit it to another device (e.g., AP MLDs and STA MLDs) within the network. In some embodiments, the transmission of the proposed preemption sequence may occur during the association process. In some embodiments, the sequence negotiation component 855 may receive proposed sequences from other parties within the network. Upon receiving a proposed sequence, the sequence negotiation component 855 may evaluate it against the requirements of the network and/or the device, and respond with adjustments, approval, or an alternative proposal. This negotiation process may ensures that all parties within the network reach a consensus on the optimal preemption sequence. In some embodiments, once the preemption sequence is negotiated and agreed upon, the sequence negotiation component 855 may keep tracking the implementation of the preemption to ensure compliance with the agreed-upon sequence, and may take corrective actions if deviations occur.

In one embodiment, the notification component 860 may generate a message (or a tag) and transmit it to the relevant devices (e.g., AP MLDs and STA MLDs) within the network. In some embodiments, the message (or the tag) may contain information about the destination link (e.g., the link to which the ongoing transmission should be preempted), the type of data being preempted, and any other necessary detail to ensure smooth link switching. The communication may ensure all parties (e.g., AP MLDs and STA MLDs) involved in the link switching process are aware of the change and can adjust their operations accordingly.

In the illustrated example, the storage 815 includes a record of preemption sequences 870 that have been proposed, adjusted, and finally agreed upon by the involved network devices. The historical record for the preemption sequences may provide valuable information to analyze the patterns and trends of network behavior. In the illustrated example, the storage 815 also includes traffic metrics 875 that reflect the current state and performance of the network. Although depicted as residing in storage 815, the preemption sequences 870 and traffic metrics may be stored in any suitable location, such as a remote database.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
transmitting, by a first network device, at least a first portion of a first element of data via a first link;
identifying, by the first network device, a second element of data;
interrupting, by the first network device, the transmission of the first element of data to transmit the second element of data via the first link; and
transmitting, by the first network device, a remaining portion of the first element of data via a second link.

2. The method of claim 1, wherein the second element of data comprises deterministic data that has a higher transmission priority than the first element of data.

3. The method of claim 1, wherein the first and second links connect the first network device to a second network device.

4. The method of claim 3, further comprising transmitting, by the first network device, at least one of a cyclic redundancy check (CRC), or a tag indicating the second link, to the second network device via the first link.

5. The method of claim 3, further comprising communicating, by the first network device and to the second network device, a defined preemption sequence between the first link and the second link.

6. The method of claim 1, wherein:
the first network device comprises a station multi-link device (STA MLD),
the first link connects the STA MLD to a first access point multi-link device (AP MLD), and
the second link connects the STA MLD to a second AP MLD.

7. The method of claim 6, wherein the second AP MLD transmits the remaining portion of the first element of data to the first AP MLD.

8. The method of claim 7, wherein the first AP MLD, upon receiving the remaining portion of the first element of data, combining the remaining portion and the first portion of the first element of data, and transmitting the first element of data to a destination.

9. The method of claim 6, wherein the first and second links operate on a same frequency band.

10. The method of claim 1, wherein:
the first network device comprises a first access point multi-link device (AP MLD),
the first link connects the first AP MLD to a station multi-link device (STA MLD), and
the second link connects a second AP MLD to the STA MLD.

11. The method of claim 10, wherein transmitting, by the first network device, the remaining portion of the first element of data via the second link comprises transmitting the remaining portion of the first element of data to the second AP MLD, wherein the second AP MLD forwards the remaining portion of the first element of data to the STA MLD via the second link.

12. The method of claim 10, wherein the first and second links operate on a same frequency band.

13. A system, comprising:
one or more computer processors; and
a memory containing a program which when executed by the one or more computer processors performs an operation, the operation comprising:
transmitting, by a first network device, at least a first portion of a first element of data via a first link;
identifying, by the first network device, a second element of data;
interrupting, by the first network device, the transmission of the first element of data to transmit the second element of data via the first link; and
transmitting, by the first network device, a remaining portion of the first element of data via a second link.

14. The system of claim 13, wherein the second element of data comprises deterministic data that has a higher transmission priority than the first element of data.

15. The system of claim 13, wherein the first and second links connect the first network device to a second network device.

16. The system of claim 15, wherein the operation further comprises transmitting, by the first network device, at least one of a cyclic redundancy check (CRC), or a tag indicating the second link, to the second network device via the first link.

17. The system of claim 15, wherein the operation further comprises communicating, by the first network device and to the second network device, a defined preemption sequence between the first link and the second link.

18. The system of claim 13, wherein:
the first network device comprises a station multi-link device (STA MLD),
the first link connects the STA MLD to a first access point multi-link device (AP MLD),
the second link connects the STA MLD to a second AP MLD, and
the second AP MLD transmits the remaining portion of the first element of data to the first AP MLD.

19. The system of claim 13, wherein:
the first network device comprises a first access point multi-link device (AP MLD),
the first link connects the first AP MLD to a station multi-link device (STA MLD),
the second link connects a second AP MLD to the STA MLD, and
the first AP MLD transmits the remaining portion of the first element of data to the second AP MLD, which forwards the remaining portion of the first element of data to the STA MLD via the second link.

20. A non-transitory computer-readable medium containing computer program code that, when executed by operation of one or more computer processors, performs an operation comprising:
transmitting, by a first network device, at least a first portion of a first element of data via a first link;
identifying, by the first network device, a second element of data;
interrupting, by the first network device, the transmission of the first element of data to transmit the second element of data via the first link; and
transmitting, by the first network device, a remaining portion of the first element of data via a second link.
